(19) United States
(12) Patent Application Publication
(10) Pub. No.: US 2016/0197905 A1
(43) Pub. Date: Jul. 7, 2016

(54) PRESENCE BASED NETWORK COMMUNICATION BLOCKING

(71) Applicant: Dulce Blanco Ltd., Ramat-Gan (IL)

(72) Inventor: Sinai LIBAL, Moshav Yashresh (IL)

(21) Appl. No.: 14/589,089

(22) Filed: Jan. 5, 2015

(51) Int. Cl. H04L 29/06

(52) U.S. Cl. CPC H04L 63/083; H04L 63/02

(57) ABSTRACT

A method of controlling network connection, comprising: establishing connection between a security monitored network and a wide area network (WAN); detecting presence status of a first network node in the security monitored network; and adjusting access of a second network node included in the security monitored network to the WAN according to the detection.

### FIELD AND BACKGROUND OF THE INVENTION

The present invention, in some embodiments thereof, relates to controlling network connection and, more particularly, but not exclusively, to controlling network connection based on presence of network member(s).

Routers connecting a security monitored network to the internet may block some or all of the network nodes (e.g. computers) in the security monitored network from accessing the internet. In some cases, this is done according to security preferences, for example as part of a firewall feature.

### SUMMARY OF THE INVENTION

According to an aspect of some embodiments of the present invention there is provided a method of controlling network connection, comprising: establishing connection between a security monitored network and a wide area network (WAN); detecting presence status of a first network node in the security monitored network; and adjusting access of a second network node included in the security monitored network to the WAN according to the detection.

Optionally, the presence status is detected by a network controller when the first network node is in proximity to the network controller.

More optionally, the network controller is included in a broadband router.

More optionally, the network controller is included in a firewall.

Optionally, the WAN includes the internet.

Optionally, the security monitored network is a local area network (LAN).

Optionally, the security monitored network is a Wireless Fidelity (WiFi™) network.

Optionally, the establishing and the detecting are done by a router.

More optionally, the adjusting is done by a network controller that is included in the router.

Optionally, the detecting is done according to a media access control (MAC) address of the first network node.

Optionally, the detecting is done according to a user logged in on the first network node.

Optionally, the detecting is done according to usage patterns of a user of the first network node.

Optionally, the detecting is authenticated by a user of the first network node.

More optionally, the authentication includes a password authentication.

Optionally, the detecting includes identifying a phone number used by the first network node when the first network node is a mobile phone.

Optionally, the adjusting is done according to a MAC address of the second network node.

Optionally, the presence status of the first network node includes a connection to the security monitored network by wireless connection.

Optionally, the adjusting is done according to a list of MAC address of network nodes.

Optionally, the adjusting includes adjusting access of a plurality of network nodes included in the security monitored network to the WAN according to the detection.

Optionally, the adjusting includes terminating the connection between the security monitored network and the WAN.

Optionally, the adjusting includes denying access of the second network node to the WAN.

Optionally, the adjusting includes allowing access of the second network node to the WAN.

Optionally, the adjusting includes limiting access of the second network node to the WAN.

Optionally, the adjusting includes allowing limited access of a group of privileged network nodes to the WAN.

Optionally, the adjusting includes restricting access from the WAN to the second network node.

Optionally, the adjusting is performed according to presence status of multiple network nodes.

Optionally, the adjusting includes blocking connection between an image rendering source of the second network node and a display device of the second network node.

Optionally, the second network node is a router connecting other network nodes.

Optionally, the second network node adjusts access of a third network node to the WAN according to the detection, the third network node is included in a second security monitored network created by the second network node.

According to some embodiments of the invention there is provided a computer readable medium comprising computer executable instructions adapted to perform the method.

According to an aspect of some embodiments of the present invention there is provided a device for controlling network connection, comprising: a routing module establishing connection between a security monitored network and a wide area network (WAN); and a network controller that: detects presence status of a first network node in the security monitored network; and adjusts access of a second network node of the security monitored network to the WAN according to the detection.

According to an aspect of some embodiments of the present invention there is provided a method of controlling network connection, comprising: establishing connection between a security monitored network and a wide area network (WAN); detecting presence status of a person in a predetermined area; and adjusting access of a second network node included in the security monitored network to the WAN according to the detection.

Optionally, the presence is detected by at least one sensor.

According to an aspect of some embodiments of the present invention there is provided a device for controlling network connection, comprising: a routing module establishing connection between a security monitored network and a wide area network (WAN); a sensor that detects presence status of a person in a predetermined area; and a network controller that adjusts access of a second network node of the security monitored network to the WAN according to the detection.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a flowchart schematically representing a method for controlling network connection, according to some embodiments of the present invention;

FIG. 2 is a schematic illustration of a device for controlling network connection, according to some embodiments of the present invention;

FIG. 3 is a flowchart schematically representing another method for controlling network connection, according to some embodiments of the present invention;

FIG. 4 is a schematic illustration of a device for controlling network connection using a sensor, according to some embodiments of the present invention;

FIG. 5 is a schematic illustration of an security monitored network, according to some embodiments of the present invention; and

FIG. 6 is a sequence chart schematically representing an exemplary scenario of controlling network connection, according to some embodiments of the present invention.

### DESCRIPTION OF EMBODIMENTS OF THE INVENTION

The present invention, in some embodiments thereof, relates to controlling network connection and, more particularly, but not exclusively, to controlling network connection based on presence of network member(s).

According to some embodiments of the present invention, there is provided a method of controlling network access of network nodes, such as computing units or mobile devices, according to presence of other network nodes in a security monitored network. The method may be used, for example, to restrict internet access of computers in a home network when an administrator user is not present at home, and/or denying internet access to other computers when one of the computers in the security monitored network is being used.

When applied, the method includes establishing connection between a security monitored network and a wide area network (WAN) such as the internet, detecting presence status of a first network node in the security monitored network and adjusting access of a second network node included in the security monitored network to the WAN, for example, denying or granting access to the WAN. Adjustment of access may include blocking, enabling or restriction of access according to whether the first network node is present or not present.

The method allows quick and automatic connection and disconnection of devices to the WAN, by maintaining a constant connection of a network controller to the WAN.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

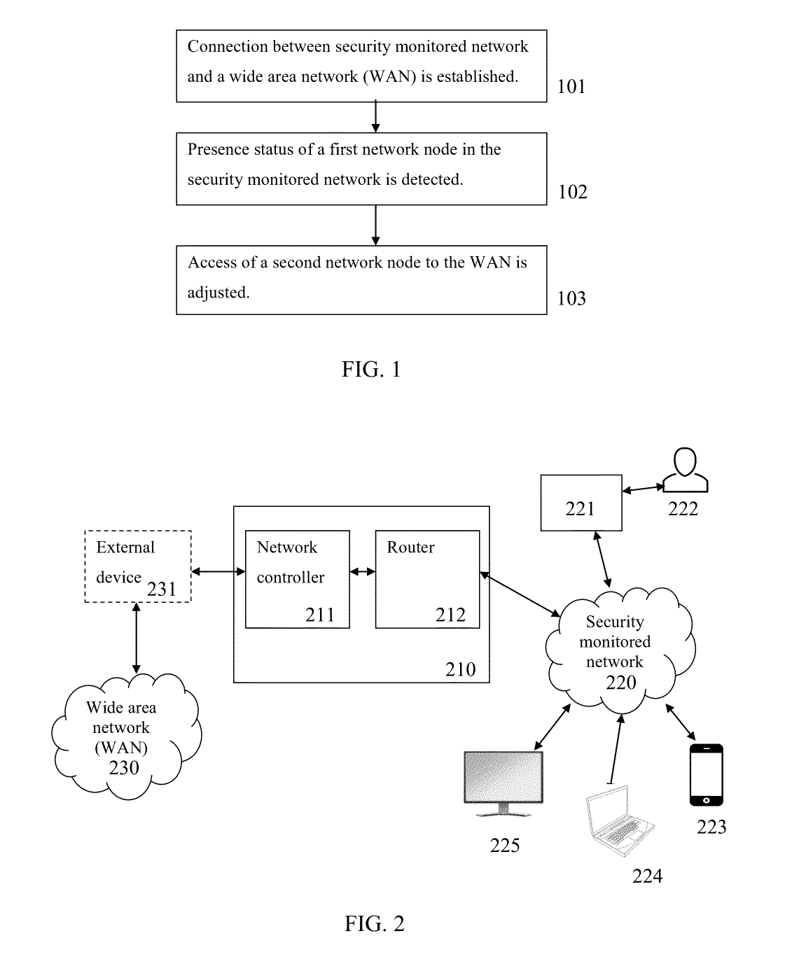

Referring now to the drawings, FIG. 1 is a flowchart schematically representing a method for controlling network connection, based on presence of member(s) in a security monitored network, according to some embodiments of the present invention. The method enables automatic control over network access according to presence status without constant manual configuration. The method provides security means in complex network environments.

Reference is also made to FIG. 2, which is a schematic illustration of a device 210 for controlling network connection, according to some embodiments of the present invention.

First, as shown at 101, connection between a security monitored network 220 and a WAN 230 is established.

Security monitored network 220 may be, for example, a local area network (LAN), a wireless network such as wireless local area network (WLAN) such as Wireless Fidelity (WiFi™) and/or a wireless personal area network (WPAN) such as Bluetooth™ protocol, and/or any other kind of connection between multiple network nodes. Security monitored network 220 may be controlled, for example, by a router 212 included in device 210 that is connected to each network node and regulates communication between the network nodes. One or more network nodes may be connected to security monitored network 220 at any specific time.

A network node may be any kind of electronic device having network connection abilities. For example, a personal computer, a mainframe computer, a printer, a scanner, a storage device, a tablet computer, a laptop computer, a mobile phone, a wearable device and/or electronic glasses.

WAN 230 may include the internet and/or a larger network then security monitored network 220 such as a LAN shared by multiple office locations. The connection between security monitored network 220 and WAN 230 may by established, for example, by router 212, when router 212 includes a modem and/or other WAN capabilities. Alternatively, the connection may by established by a network controller 211 included in device 210 that is connected to router 212 and connected to an external device 231 that includes a router and/or a modem. Optionally, network controller 211 is included in router 212.

Optionally, router 212 may be a mobile device providing access to WAN 230 for other network nodes, for example by a second security monitored network such as WiFi network created by mobile hotspot.

Then, as shown at 102, presence status of a first network node 221 in security monitored network 220 is detected. Detection of presence status may conclude that first network node 221 is present or not present in security monitored network 220. First network node 221 may be any kind of device, as described above. For example, when user 222 leaves the house, first network node 221, which may be a mobile phone, is disconnected from security monitored network 220.

The detection may be performed by router 212, for example through a wireless connection established by router 212 that connects first network node 221.

Optionally, first network node 221 is detected according to a media access control (MAC) address of first network node 221.

Optionally, first network node 221 is detected according to a user 222 logged in on first network node 221. For example, when first network node 221 is a computer having multiple user accounts, detection is made when user 222 is logged in to his account. Optionally, user 222 is detected when using first network node 221 according to use patterns of the network, for example, entering specific websites, using specific programs, typing typical keywords and/or any other pattern.

Finally, as shown at 103, access of a second network node 223 to WAN 230 is adjusted according to the detection of first network node 221. Second network node 222 may be any kind of device, as described above. Optionally, access of other network nodes 224 and 225 to WAN 230 is adjusted. Optionally, network node 223 is used as a router for connecting network nodes 224 and/or 225. Optionally, access to WAN 230 of each network nodes 224 and/or 225 connected through network node 223 is adjusted separately.

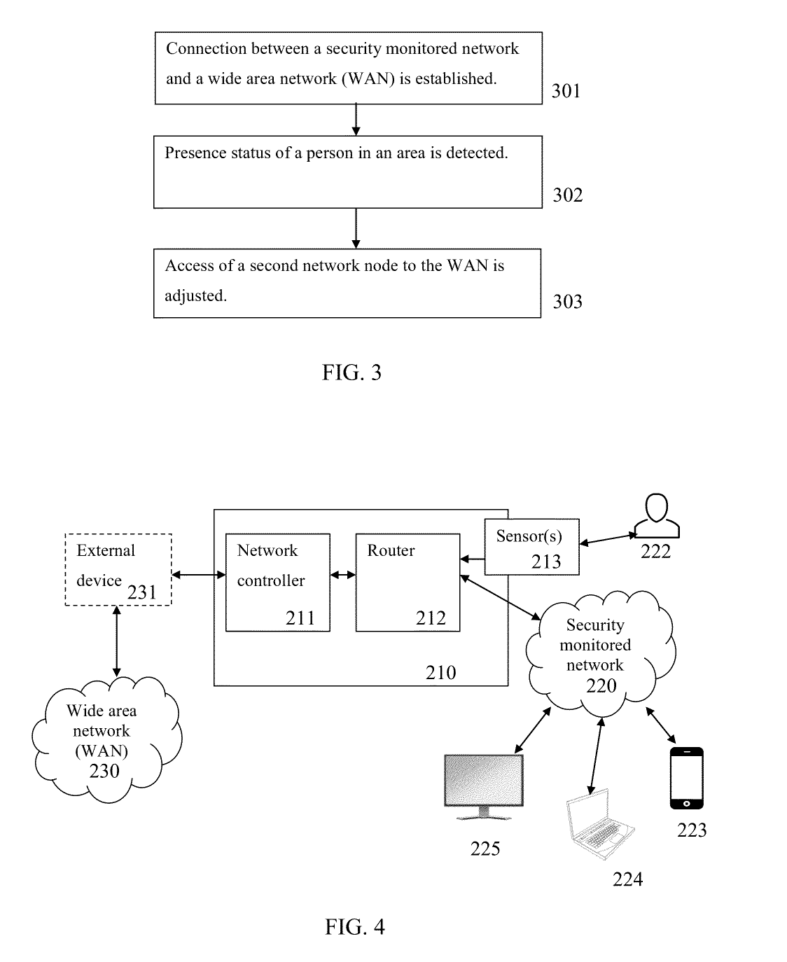

Reference is now made to FIG. 3, which is a flowchart schematically representing a method for controlling network connection, based on presence of a person, according to some embodiments of the present invention. Reference is also made to FIG. 4, which is a schematic illustration of a device for controlling network connection, based on presence of a person, according to some embodiments of the present invention. Blocks 301 and 303 are as described in FIG. 1 for blocks 101 and 103. As shown in 302, presence status of a person 222 in a predetermined area is detected. The area may be, for example, the inside of a residence, a workplace, the vicinity of a computer, the area covered by a wireless network and/or any other area. The presence of user 222 is directly detected, for example, by using a sensor(s) 213 such as camera(s), audio sensor(s) and/or motion detector(s) and recognizing user 222 by using facial recognition, voice recognition and/or pattern detection algorithms accordingly. For example, a specific person is detected sitting in front of a desktop computer 221.

The adjustment may be performed by network controller 211. Optionally, network controller 211 includes a firewall or is included in a firewall device. Optionally, network controller 211, router 212 and/or a firewall are combined in device 210. The adjustment may be done by adjustment of access to network nodes according to their MAC addresses. Optionally, the configuration of the adjustment is predetermined and/or may be configured by a user using an interface of network controller 211.

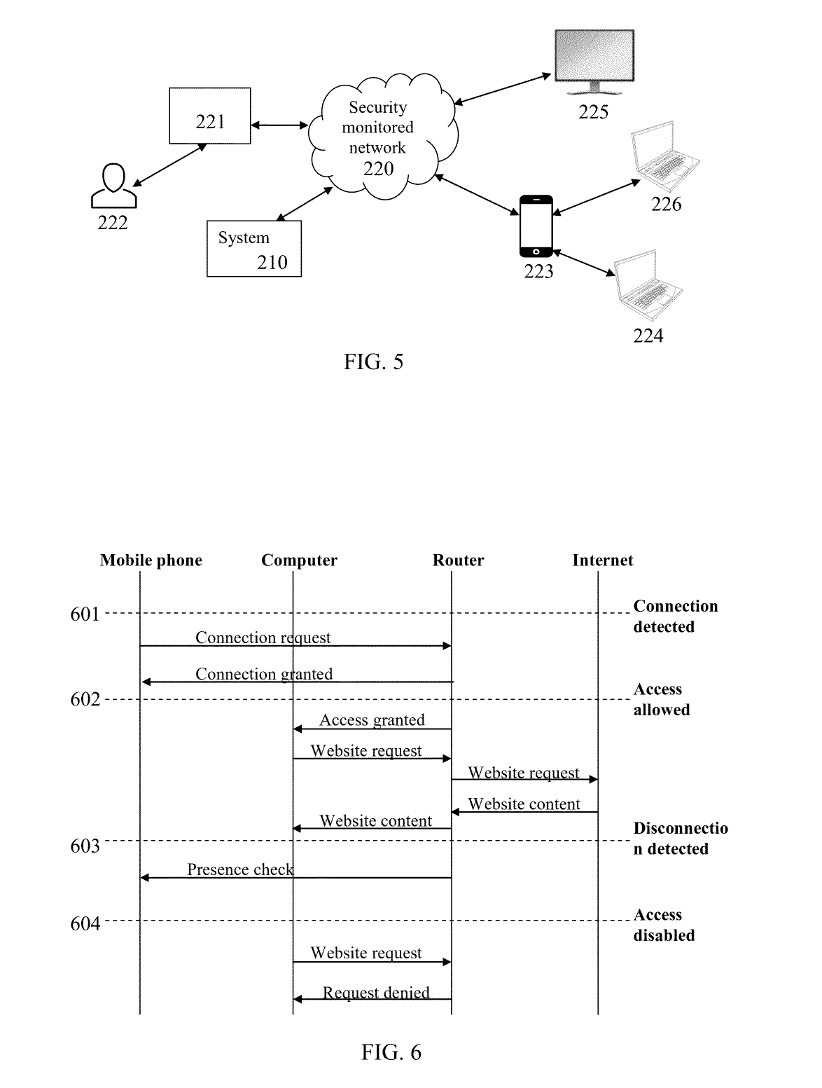

Reference is also made to FIG. 5, which is a schematic illustration of a security monitored network 220, according to some embodiments of the present invention. Optionally, the adjustment includes inherency of the configuration of the adjustment from one network node to another. For example, when network node 223 is used as a router and/or is a mobile device creating mobile hotspot, network node 223 may adjust access to WAN 230 of network nodes 224 and 226 connected to it, according to the detection of first network node 221. Optionally, network nodes 224 and/or 226 may also adjust access to WAN 230 of further network nodes connected to them. The inherency may be done, for example, by sending a message indicative of the configuration of the adjustment from router 212 to network node 223 and from network node 223 to any other device.

Optionally, the adjustment includes blocking access of second network node 223 to WAN 230. For example, when user 222 leaves the house with first network node 221, second network node 223, which may be a desktop computer is prevented from accessing the internet, for security purposes.

Optionally, the adjustment includes enabling access of second network node 223 to WAN 230. For example, when first network node 221, which may be a desktop computer, is turned off, second network node 223, which may be another desktop computer is granted access to the internet.

Optionally, the adjustment includes restricting access of second network node 223 to WAN 230. The restriction may include preventing access to certain locations in WAN 230, restricting bandwidth used by second network node 223 to connect to WAN 230, limit the connection period of second network node 223 to WAN 230, limit the connection to communications initiated by second network node 223 and/or any other restriction. For example, when a parent using first network node 221 leaves the house, a child protection restriction is applied to all home computers.

Optionally, the adjustment includes preventing access from WAN 230 to second network node 223 and/or any other network node, thus providing a security measure against unauthorized external access.

Optionally, the adjustment includes terminating connection between security monitored network 220 and WAN 230. For example, when a user turns off his computer and leaves the office, the office network is disconnected from the internet.

Optionally, the adjustment is performed according to detection of presence status of multiple network nodes. For example, internet access of a home desktop computer is blocked when all of the mobile phones of family members are not present.

Optionally, the adjustment includes blocking connection between an image rendering source of second network node 223, such as a desktop computer, and a display device of second network node 223, such as a computer screen. This may be done, for example, by a controller that blocks the display output signal.

According to an exemplary embodiment of the present invention, a home broadband router that includes a network switch, a firewall, and a DHCP server crates a wireless WiFi network having a limited radius, for example, of 10 meters. The router is connected to a modem that establishes internet connectivity via a wide area network (WAN) connection.

Reference is also made to FIG. 6, which is a sequence chart schematically representing an exemplary scenario of controlling network connection, according to some embodiments of the present invention.

As shown in 601, the router detects a connection of a mobile phone to the WiFi network. This occurs when the mobile phone is in physical proximity of the router and within the radius of the router's WiFi network. The mobile phone is identified by its MAC address that is sent to the router upon connection. The router identifies that the MAC address is listed as a presence indicating device according to a list of MAC addresses stored in the router. Optionally, the user of the mobile phone is identified, for example by a password authentication and/or a phone number of the mobile phone.

As shown in 602, the router allows internet access to a group of restricted computing devices connected to the router via the WiFi network or via Ethernet connection, such as desktop computer and/or laptop computer. This is done by the router by forwarding data packets from the computing devices to the internet and vice versa. The group of restricted computing devices is identified by their MAC addresses according to a list of MAC addresses stored in the router.

As shown in 603, the mobile phone is disconnected from the WiFi network. As shown in 604, the router than disables the connection of the restricted computing devices to the internet by not transferring data packets from the restricted computing devices to the internet and vice versa. Optionally, a group of privileged devices, for example a refrigerator and/or a washing machine, is allowed limited interned connectivity when the presence indicating device is not connected to the network.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant network controllers will be developed and the scope of the term controlling network connection is intended to include all such new technologies a priori.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of controlling network connection, comprising:
establishing connection between a security monitored network and a wide area network (WAN);
detecting presence status of a first network node in said security monitored network; and
adjusting access of a second network node included in said security monitored network to said WAN according to said detection.

2. The method of claim 1, wherein said presence status is detected by a network controller when said first network node is in proximity to said network controller.

3. The method of claim 2, wherein said network controller is included in a broadband router.

4. The method of claim 2, wherein said network controller is included in a firewall.

5. The method of claim 1, wherein said WAN includes the internet.

6. The method of claim 1, wherein said security monitored network is a local area network (LAN).

7. The method of claim 1, wherein said security monitored network is a Wireless Fidelity (WiFi™) network.

8. The method of claim 1, wherein said establishing and said detecting are done by a router.

9. The method of claim 8, wherein said adjusting is done by a network controller that is included in said router.

10. The method of claim 1, wherein said detecting is done according to a media access control (MAC) address of said first network node.

11. The method of claim 1, wherein said detecting is done according to a user logged in on said first network node.

12. The method of claim 1, wherein said detecting is done according to usage patterns of a user of said first network node.

13. The method of claim 1, wherein said detecting is authenticated by a user of said first network node.

14. The method of claim 13, wherein said authentication includes a password authentication.

15. The method of claim 1, wherein said detecting includes identifying a phone number used by said first network node when said first network node is a mobile phone.

16. The method of claim 1, wherein said adjusting is done according to a MAC address of said second network node.

17. The method of claim 1, wherein said presence status of said first network node includes a connection to said security monitored network by wireless connection.

18. The method of claim 1, wherein said adjusting is done according to a list of MAC address of network nodes.

19. The method of claim 1, wherein said adjusting includes adjusting access of a plurality of network nodes included in said security monitored network to said WAN according to said detection.

20. The method of claim 1, wherein said adjusting includes terminating said connection between said security monitored network and said WAN.

21. The method of claim 1, wherein said adjusting includes denying access of said second network node to said WAN.

22. The method of claim 1, wherein said adjusting includes allowing access of said second network node to said WAN.

23. The method of claim 1, wherein said adjusting includes limiting access of said second network node to said WAN.

24. The method of claim 1, wherein said adjusting includes allowing limited access of a group of privileged network nodes to said WAN.

25. The method of claim 1, wherein said adjusting includes restricting access from said WAN to said second network node.

26. The method of claim 1, wherein said adjusting is performed according to presence status of multiple network nodes.

27. The method of claim 1, wherein said adjusting includes blocking connection between an image rendering source of said second network node and a display device of said second network node.

28. The method of claim 1, wherein said second network node is a router connecting other network nodes.

29. The method of claim 1, wherein said second network node adjusts access of a third network node to said WAN according to said detection, said third network node is included in a second security monitored network created by said second network node.

30. A computer readable medium comprising computer executable instructions adapted to perform the method of claim 1.

31. A device for controlling network connection, comprising:
a routing module establishing connection between a security monitored network and a wide area network (WAN); and
a network controller that:
detects presence status of a first network node in said security monitored network; and
adjusts access of a second network node of said security monitored network to said WAN according to said detection.

32. A method of controlling network connection, comprising:
establishing connection between a security monitored network and a wide area network (WAN);
detecting presence status of a person in a predetermined area; and
adjusting access of a second network node included in said security monitored network to said WAN according to said detection.

33. The method of claim 32, wherein said presence is detected by at least one sensor.

34. A device for controlling network connection, comprising:
a routing module establishing connection between a security monitored network and a wide area network (WAN);
a sensor that detects presence status of a person in a predetermined area; and
a network controller that adjusts access of a second network node of said security monitored network to said WAN according to said detection.
